(19) United States
(12) Patent Application Publication
(10) Pub. No.: US 2018/0201886 A1
(43) Pub. Date: Jul. 19, 2018

(54) WATER-SOLUBLE RECEPTACLE COMPRISING A COATING

(71) Applicant: Henkel AG & Co. KGaA, Duesseldorf (DE)

(72) Inventors: Alexander Schulz, Essen (DE); Kerstin Schmitz, Duesseldorf (DE); Yvonne Willemsen, Korschenbroich (DE); Michael Horn, Duesseldorf (DE); Bianka Handke, Hilden (DE); Uwe Trebbe, Duesseldorf (DE); Volker Blank, Leverkusen (DE); Katja Gerhards, Duesseldorf (DE); Matthias Sunder, Duesseldorf (DE); Salvatore Fileccia, Oberhausen (DE)

(73) Assignee: Henkel AG & Co. KGaA, Duesseldorf (DE)

(21) Appl. No.: 15/920,579

(22) Filed: Mar. 14, 2018

Related U.S. Application Data
(63) Continuation of application No. PCT/EP2016/071902, filed on Sep. 15, 2016.

(30) Foreign Application Priority Data
Sep. 16, 2015 (DE) 102015217759.9

(51) Int. Cl. C11D 17/04; C11D 3/00; C11D 3/37

(52) U.S. Cl. CPC C11D 17/042; C11D 3/3753; C11D 3/3715; C11D 3/0036

(57) ABSTRACT

A water-soluble receptacle for a detergent, cleaning agent or pretreatment agent, the receptacle being coated with detergent polymeric active substance. Also disclosed are a portioned detergent, cleaning agent or pretreatment agent in a water-soluble receptacle of the type as well as a method for making a corresponding water-soluble receptacle.

### FIELD OF THE INVENTION

The present invention relates to a water-soluble receptacle for a washing, cleaning, or pretreatment agent, a portioned washing, cleaning, or pretreatment agent in a water-soluble receptacle, and a method for producing a corresponding water-soluble receptacle.

### BACKGROUND OF THE INVENTION

Polymers of widely different properties play an increasingly large role in modern washing agents. The polymers in question are often polymers that increase the cleaning performance of a washing agent or that have a care effect. Examples of such active ingredients are soil release polymers, graying inhibitors, primary-detergency intensifiers, softeners, or anti-wrinkling active ingredients.

The consumer would like to be able to remove stains on textiles as completely as possible. This goal can be achieved not only by improving the primary performance but also, for example, by using soil release polymers. It is suspected that such polymers are deposited onto the textile during the washing cycle. When the textile is subsequently soiled, the polymer is present as a protective film between the fibers and the stain so that the stain can be better and more easily removed in the subsequent washing cycle.

Today, washing, cleaning, or pretreatment agents are often provided pre-portioned into corresponding receptacles in an amount suitable for one wash load. Active ingredients can be packaged separate from each other. Furthermore, the dosage is optimal for one washing, cleaning, or pretreatment cycle. The receptacles are typically produced from a water-soluble material so that the washing, cleaning, or pretreatment agents contained in the receptacles effectively come in contact with the items to be cleaned. Water-soluble means that the material dissolves or disperses in water. However, in addition to the simple handling by virtue of the prepared dosage for one washing cycle, the consumer also demands an attractive appearance. Today, the receptacles are typically transparent so that the agents contained therein are completely visible.

The market share of liquid washing agents and concentrates, including pre-dosed concentrates, continues to rise. Liquid agents too can be provided pre-portioned in corresponding receptacles. However, it is problematic to stably incorporate certain polymeric active ingredients into a liquid formation.

In particular when formulating liquid washing, cleaning, or pretreatment agents, the problem arises that such polymeric active ingredients are not soluble or should not be soluble in the liquid agent. It is therefore often hardly possible to formulate clear and aesthetically pleasing opaque products. In addition, when certain active ingredients are incorporated into liquid washing, cleaning, or pretreatment agents, there can be incompatibility between the individual active-ingredient components. This can lead to undesirable discolorations, agglomerations, odor problems, or interference with the washing-active active ingredients such as the surfactants.

It would be possible to disperse the polymeric active ingredients as solids in liquid washing, cleaning, or pretreatment agents, but in many cases this leads to a product that is aesthetically deficient, because the polymeric active ingredient, which is usually not soluble in the liquid agent, often precipitates out in the form of irregularly shaped particles as flocs or precipitate. If the polymeric active ingredient should be soluble, phase separation can occur, in particular in the case of partial solubility, and as a result the product does not have an attractive appearance.

However, the consumer demands washing, cleaning, or pretreatment agents which, at the time of use, even after storage and transport, are visually appealing and optimally effective in a consistent manner for each washing cycle. This requires that the ingredients also of the liquid washing, cleaning, or pretreatment agent have not previously settled out, decomposed, or evaporated.

### BRIEF SUMMARY OF THE INVENTION

The problem addressed by the present invention is that of providing a visually appealing product by means of which washing, cleaning, or pretreatment agents can be provided in a prefabricated form. In addition, the disadvantages from the prior art, in particular with regard to polymeric active ingredients, should be avoided.

Surprisingly, it has been found that it is possible to provide a coating comprising at least one polymeric active ingredient to receptacles for washing, cleaning, or pretreatment agents. This avoids the problem that polymeric active ingredients are difficult to incorporate, particularly into liquid washing, cleaning, or pretreatment agents, because the polymer is not incorporated into the agent itself but instead becomes part of the receptacle in which the washing, cleaning, or pretreatment agent is dosed. In a first embodiment, the invention on which the present problem is based is therefore solved by means of a water-soluble receptacle for a washing, cleaning, or pretreatment agent having a first surface, which forms the inner face of the receptacle, and a second surface as the outer face of the receptacle, which second surface lies opposite said first surface, wherein said second surface has a coating over the full area thereof or over part of the area thereof and said coating comprises at least one polymeric active ingredient.

The coating is located on the second surface of a receptacle. The receptacle is, for example, a bag, pouch, or other container, which can contain a washing, cleaning, or pretreatment agent, which, during use, can be used by the consumer directly as a pre-dosed portion. The washing, cleaning, or pretreatment agent is contained within the container. The inner face of the receptacle forms the first surface, which is contacted with the washing, cleaning, or pretreatment agent. The second surface lies opposite the first surface. The second surface therefore forms the outer face of the receptacle during use of the water-soluble receptacle. There is a full-area or partial-area coating on said second surface. This means that the entire receptacle can be coated on the surface. A homogenous outer appearance of the receptacle would therefore be provided for the consumer. However, it is also possible, and preferred according to the invention, that the receptacle is not fully coated. According to the invention, it is possible instead that an attractive outward appearance of the receptacle is produced by means of a partial-area coating. In this way, geometric patterns or graphic designs in the form of images, for example, can be applied to the second surface of the receptacle.

The coating comprises at least one polymeric active ingredient. According to the invention, said polymeric active ingredient is a polymer that is also typically contained as a component of a washing, cleaning, or pretreatment agent. The at least one polymeric active ingredient is preferably selected from the group of the soil release polymers, polymeric graying inhibitors, polymeric primary-detergency intensifiers, polymeric softeners, and polymeric anti-wrinkling active ingredients. The coating can have one of the mentioned polymeric active ingredients. However, it is also possible that several different polymeric active ingredients are contained in the coating. Thus, a coating can comprise, for example, a soil release polymer and a polymeric graying inhibitor. However, it is also possible that the coating has, for example, two or more different soil release polymers.

If the polymeric active ingredient is a graying inhibitor, the polymeric active ingredient is, in particular, a cellulose derivative. Intensifiers of primary detergency are, in particular, PEI and/or PVP and derivatives thereof. Polymeric anti-wrinkling active ingredients are present, in particular, as siloxanes or polyurethanes, while modified siloxanes can preferably also be contained in the coating as polymeric softeners.

Particularly preferably, the coating comprises at least one soil release polymer as a polymeric active ingredient, in particular an anionic or a non-ionic soil release polymer, which preferably has a phthalate group and/or is a polyester. An anionic soil release polymer that is a polyester having a phthalate group is preferred.

### DETAILED DESCRIPTION OF THE INVENTION

In a preferred embodiment, the polymeric active ingredient is therefore at least one soil release polymer and/or at least one graying inhibitor, for example a cellulose derivative, such as methyl cellulose, carboxymethyl cellulose, or hydroxypropyl methyl cellulose. Soil release polymers reduce the resoiling of textiles after washing. These soil release polymers preferably have a phthalate group. Such soil release polymers preferably suitable as polymeric active ingredients in the coating are described below. The polymeric active ingredient is preferably a polyester, containing at least one structural unit of formula (I) and at least one structural unit of formula (II)

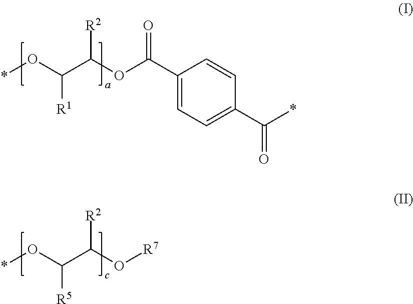

wherein

a and c represent, independently of each other, a number from 1 to 200,

R¹, R², R⁵, and R⁶ represent, independently of each other, hydrogen or a C₁ or C₂ to C₁₈ n-alkyl group or C₃ or C₄ to C₁₈ isoalkyl group,

R⁷ represents a linear or branched C₁ or C₂-C₃₀ alkyl group or a linear or branched C₂ or C₃ to C₃₀ alkenyl group, a cycloalkyl group having 5 to 9 carbon atoms, a C₆ to C₃₀ aryl group, or a C₆ to C₃₀ arylalkyl group.

Exceedingly preferred as a polymeric active ingredient is an anionic polyester, containing at least one structural unit of formula (I), at least one structural unit of formula (II), and at least one structural unit of formula (III)

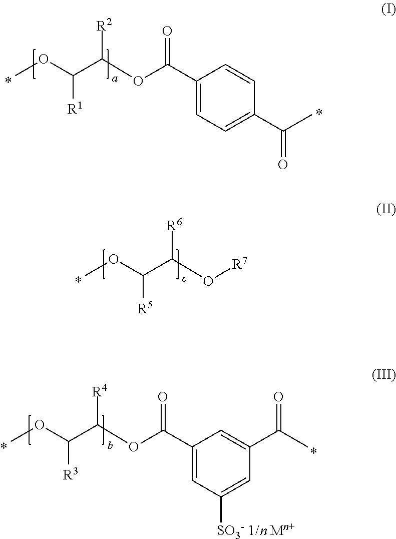

wherein

a, b, and c represent, independently of each other, a number from 1 to 200,

1/n Mⁿ⁺ represents an equivalent of a cation having the charge number n, with n=1, 2, or 3,

R¹, R², R³, R⁴, R⁵, and R⁶ represent, independently of each other, hydrogen or a C₁ or C₂ to C₁₈ n-alkyl group or C₃ or C₄ to C₁₈ isoalkyl group,

R⁷ represents a linear or branched C₁ or C₂ to C₃₀ alkyl group or a linear or branched C₂ or C₃ to C₃₀ alkenyl group, a cycloalkyl group having 5 to 9 carbon atoms, a C₆ to C₃₀ aryl group, or a C₆ to C₃₀ arylalkyl group. This preferred polyester is referred to as “anionic polyester” below.

A chemical bond marked with a * in formulas (I), (II), and (III) means a free valence of the structural element in question, which free valence forms an ester bond in the polymer backbone of the polyester, for example either with one of said structural elements of formula (I) or of formula (III) or with a further at least bivalent structural element. To form a polymer terminus, said valences of formula (I) or (III) bond to the structural element of formula (II) or to a further, monovalent structural element, an ester bond thus being formed.

The (preferably anionic) polyesters according to the invention are copolyesters that can be formed at least from monomers which, after a polymerization reaction, result in corresponding structural units of formulas (I) and (II) and preferably (III) at least in the polymer backbone. Such polyesters can be obtained, for example, by the polycondensation of terephthalic acid dialkyl ester (and preferably 5-sulfoisophthalic acid dialkyl ester and alkylene glycols and optionally polyalkylene glycols (in the case of a, b, and/or c>1) and polyalkylene glycols end-capped at one end. The (preferably anionic) polyesters according to the invention can be synthesized in accordance with known methods, for example by first heating the aforementioned components at normal pressure, a catalyst also being added, and then building up the required molecular weights in a vacuum by distilling off hyperstoichiometric amounts of the glycols that are used. The known transesterification and condensation catalysts, such as titanium tetraisopropylate, dibutyltin oxide, alkali metal or alkaline-earth metal alcoholates, or antimony trioxide/calcium acetate, are suitable for the reaction. With regard to further details, reference is made to EP 442 101. Said structural units can be present in the polyester molecule of said anionic polyester either in blocks or in statistical distribution.

Furthermore, the (particularly preferably anionic) polyester preferably contains, on a number-average basis,

between 1 and 25, in particular between 1 and 10, particularly preferably between 1 and 5, structural units of formula (I) and

between 0.05 and 15, in particular between 0.1 and 10, and particularly preferably between 0.25 and 3, structural units of formula (II) and,

if anionic, particularly preferably between 1 and 30, in particular between 2 and 15, particularly preferably between 3 and 10, structural units of formula (III).

The (preferably anionic) polyesters, containing the structural units (I), (II), and preferably (III) (and possibly (IV); see above), preferably have number-average molecular weights in the range of 700 to 50,000 g/mol, wherein the number-average molecular weight can be determined by size-exclusion chromatography in an aqueous solution with the use of calibration by means of narrowly distributed polyacrylic acid sodium salt standards. The number-average molecular weights are preferably in the range of 800 to 25,000 g/mol, in particular 1,000 to 15,000 g/mol, particularly preferably 1,200 to 12,000 g/mol.

It is preferred according to the invention that 1/n Mⁿ⁺ according to formula (III) represents Li⁺, Na⁺, K⁺, 1/2 Mg²⁺, 1/2 Ca²⁺, 1/3 Al³⁺, NH₄⁺, or monoalkyl-, dialkyl-, trialkyl-, or tetraalkylammonium, wherein the alkyl functional groups of the ammonium ions are C₁ to C₂₂ alkyl functional groups or C₂ to C₁₀ hydroxyalkyl functional groups or any mixtures thereof.

The polymeric active ingredient is preferably at least one anionic polyester in which accordingly in formulas (I), (II), and (III)

R¹, R², R³, R⁴, R⁵, and R⁶ represent, independently of each other, hydrogen or methyl,

R⁷ represents methyl, and/or

a, b, and c represent, independently of each other, a number from 1 to 200, in particular 1 to 20, particularly preferably 1 to 5, extraordinarily preferably a and b mean 1 and/or c is a number from 2 to 10.

Furthermore, the (particularly preferably anionic) polyester contained as a polymeric active ingredient preferably contains, on a number-average basis,

between 1 and 25, in particular between 1 and 10, particularly preferably between 1 and 5, structural units of formula (I) and

between 0.05 and 15, in particular between 0.1 and 10, and particularly preferably between 0.25 and 3, structural units of formula (II) and

particularly preferably additionally between 1 and 30, in particular between 2 and 15, particularly preferably between 3 and 10, structural units of formula (III).

Exceedingly preferred are anionic polyesters as the polymeric active ingredient in which accordingly in formulas (I), (II), and (III)

R¹, R², R³, R⁴, R⁵, and R⁶ represent, independently of each other, hydrogen or methyl,

R⁷ represents methyl, and

a, b, and c represent, independently of each other, a number from 1 or 2 to 200, in particular 1 or 2 to 20, particularly preferably 1 or 2 to 5, extraordinarily preferably a and b mean 1 and c is a number from 2 to 10,

wherein the total amount of said anionic polyester contained in the suspended solid particles, on a number-average basis,

between 1 and 25, in particular between 1 and 10, particularly preferably between 1 and 5, structural units of formula (I),

between 0.05 and 15, in particular between 0.1 and 10, and particularly preferably between 0.25 and 3, structural units of formula (II),

between 1 and 30, in particular between 2 and 15, particularly preferably between 3 and 10, structural units of formula (III).

Such polyesters can be obtained, for example, by the polycondensation of terephthalic acid dialkyl ester, 5-sulfoisophthalic acid dialkyl ester, alkylene glycols, optionally polyalkylene glycols (in the case of a, b, and/or c>1), and polyalkylene glycols end-capped at one end (corresponding to unit of formula II).

An ester of terephthalic acid with one or more difunctional, aliphatic alcohols is possible as a unit of formula (I). Ethylene glycol (R₁ and R₂ are each H) and/or 1,2-propylene glycol (R₁=H and R₂=—CH₃ or vice versa) and/or shorter-chain polyethylene glycols and/or poly(ethylene glycol-co-propylene glycol) having number-average molecular weights of 100 to 2000 g/mol are preferably used.

Poly(ethylene glycol-co-propylene glycol)-monomethyl ethers having number-average molecular weights of 100 to 2000 g/mol and polyethylene glycol monomethyl ethers of the general formula CH₃—O—(C₂H₄O)ₙ—H with n=1 to 99, in particular 1 to 20, and particularly preferably 2 to 10, are preferably used as polyalkylene glycol monoalkyl ethers non-ionically capped at one end according to the unit of formula (II). Because the use of such ethers capped at one end defines the theoretical maximum average molecular weight of a polyester structure that can be achieved in quantitative conversion, the preferred usage amount of structural unit (II) is the usage amount necessary to achieve preferred average molecular weights (see above).

An ester of 5-sulfoisophthalic acid with one or more difunctional, aliphatic alcohols is possible as a unit of formula (III). Those mentioned above are preferably used.

In a special embodiment of the invention, the (preferably anionic) polyester as a polymeric active ingredient additionally contains at least one structural unit of formula IV,

-[polyfunctional unit-]_{g} (IV)

in which

g represents a number from 0 to 5,

polyfunctional unit represents a unit having 3 to 6 free valences, which can bond to the polymer structure by means of ester groups.

In addition to linear polyesters resulting from the structural units (I), (II) (and preferably (III)), the use of cross-linked or branched polyester structures is also in accordance with the invention. This is expressed by the presence of a cross-linking polyfunctional structural unit (IV) having at least three to at most six functional groups capable of esterification reaction. Acid groups, alcohol groups, ester groups, anhydride groups, and epoxy groups are mentioned as examples of functional groups. Different functionalities in one molecule are also possible. Citric acid, malic acid, tartaric acid, gallic acid, and particularly preferably 2,2-bis(hydroxymethyl)propionic acid can serve as examples of this. Polyhydric alcohols such as pentaerythritol, glycerol, sorbitol, and/or trimethylolpropane also can be used. Polyvalent aliphatic or aromatic carboxylic acids, such as benzene-1,2,3 -tricarboxylic acid (hemimellitic acid), benzene-1,2,4-tricarboxylic acid (trimellitic acid), or benzene-1,3,5-tricarboxylic acid (trimesic acid), are also possible. The weight percentage of cross-linking monomers with respect to the total mass of the anionic polyester can be, for example, up to 10 wt %, in particular up to 5 wt %, and particularly preferably up to 3 wt %.

According to the invention, solid (particularly preferably anionic) polyesters having softening points above 40° C. are preferably used as a polymeric active ingredient; said polyesters preferably have a softening point between 50 and 200° C., particularly preferably between 80° C. and 150° C., and extraordinarily preferably between 100° C. and 120° C.

The coating can also have further components. For example, the coating can comprise a plasticizer. The plasticizer influences the flow behavior of the polymeric active ingredient during application so that, in the case of a partial-area coating, certain patterns can be realized particularly well on the second surface. Typical external plasticizers can be used. These plasticizers are not covalently integrated into the polymer but rather interact with the polymer by means of polar groups. This does not influence the effect of the polymeric active ingredient. The plasticizers must meet the ecological and toxicological standards for washing, cleaning, or pretreatment agents. Furthermore, the plasticizers must not negatively affect the cleaning performance of the agents. The plasticizer, if contained in the coating, is preferably selected from dioctyl phthalate, phosphoric acid ester, alkylsulfonic acid ester, and/or citric acid ester. In particular, the plasticizer is selected from dioctyl phthalate, phosphoric acid ester, and/or alkylsulfonic acid ester. For example, bis(2-ethylhexyl) phthalate, tris(2-ethylhexyl) phosphate (TOF), or different alkylsulfonic acid esters can be used. Glycerol-based plasticizers, such as glycerol triacetate, are not preferred, in particular if the polymeric active ingredient is a polyester, in particular a polyester previously described as preferred (see above). According to the invention, the coating is preferably free of glycerol triacetate and other glycerol-based plasticizers, in particular if the polymeric active ingredient is a polyester, in particular a polyester previously described as preferred (see above).

The coating can also have optical auxiliaries so that the coating can influence in particular the optical impression of the receptacle. The optical auxiliaries can be, for example, dyes, optically visible particles, glitter, interference pigments, or the like. The optical auxiliaries are selected in such a way that the optical auxiliaries do not adhere to the items treated with the agents.

As a result of applying the washing-active polymeric active ingredient to the surface of the receptacle, the solubility of said polymeric active ingredient in the washing agent formula is no longer relevant. Rather, only the solubility in the washing liquid is relevant. Because a large amount of water is present in the washing liquid, the polymeric active ingredient readily dissolves and thus can be absorbed onto the textile. Therefore, the typical problem of solubility in the production of liquid washing, cleaning, or pretreatment agents does not exist here.

A water-soluble receptacle according to the invention is typically produced from a film. The water-soluble material of the receptacle or of the film can be a water-soluble material known in the prior art. The water solubility of the material can be determined in accordance with the following measurement protocol by means of a square film of said material (film: 22×22 mm with a thickness of 76 μm), which is fastened in a square frame (edge length on the inside: 20 mm). Said framed film is immersed in 800 mL of distilled water temperature-controlled to 20° C. in a 1-liter beaker having a circular bottom surface (company Schott, Mainz, 1000-mL low-form beaker) in such a way that the surface of the clamped film is arranged at a right angle to the bottom surface of the beaker, the top edge of the frame is 1 cm below the water surface, and the bottom edge of the frame is oriented parallel to the bottom surface of the beaker in such a way that the bottom edge of the frame extends along the radius of the bottom surface of the beaker and the center of the bottom edge of the frame is arranged over the center of the radius of the beaker bottom. While stirring is performed (stirring speed of magnetic stirrer: 300 rpm, stirring bar: 6.8 cm long, diameter of 10 mm), the material should dissolve within 600 seconds in such a way that individual solid film particles are no longer visible with the naked eye.

Preferred water-soluble materials preferably at least partly comprise at least one substance from the group consisting of (acetalated) polyvinyl alcohol, polyvinylpyrrolidone, polyethylene oxide, gelatin, polyvinyl alcohols substituted with sulfate, carbonate, and/or citrate, polyalkylene oxides, acrylamides, cellulose esters, cellulose ethers, cellulose amides, celluloses, polyvinyl acetates, polycarboxylic acids and salts thereof, polyamino acids or peptides, polyamides, polyacrylamides, copolymers of maleic acid and acrylic acid, copolymers of acrylamides and (meth)acrylic acid, polysaccharides, such as starch or guar derivatives, gelatin, and the substances under the INCI names Polyquaternium-2, Polyquaternium-17, Polyquaternium-18, and Polyquaternium-27. The water-soluble material is particularly preferably a polyvinyl alcohol.

In one embodiment of the invention, the water-soluble material comprises mixtures of different substances. Such mixtures make it possible to set the mechanical properties of the receptacle and can influence the degree of water solubility.

“Polyvinyl alcohols” (abbreviation PVAL, occasionally also PVOH) is the name for polymers that comprise vinyl alcohol as a repeating unit, the vinyl alcohol being alpha,beta-linked in the polymer

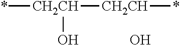

wherein alpha,alpha-links of the following type

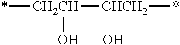

can also be contained in the polymer in small percentages (approximately 2%).

Commercially available polyvinyl alcohols, which are offered as yellowish white powders or granular materials with degrees of polymerization in the range of approximately 100 to 2500 (molar masses of approximately 4000 to 100,000 g/mol), have degrees of hydrolysis of 98 to 99 mol % or 87 to 89 mol % and therefore still have a residual content of acetyl groups. The polyvinyl alcohols are characterized by the manufacturers by specification of the degree of polymerization of the starting polymers, the degree of hydrolysis, the saponification number, or the solution viscosity.

Polyvinyl alcohols are soluble in water and a few highly polar organic solvents (formamide, dimethylformamide, dimethyl sulfoxide) in accordance with the degree of hydrolysis. Polyvinyl alcohols are not attacked by (chlorinated) hydrocarbons, esters, fats, or oils. Polyvinyl alcohols are classified as toxicologically harmless and are at least partially biodegradable. The water solubility can be reduced by posttreatment with aldehydes (acetalation), by complexation with Ni salts or Cu salts, or by treatment with dichromates, boric acid, or borax. The receptacles made of polyvinyl alcohol are largely impermeable to gases, such as oxygen, nitrogen, helium, hydrogen, and carbon dioxide, but allow water vapor to pass through.

In the scope of the present invention, it is preferred that the water-soluble material at least partly comprises a polyvinyl alcohol having a degree of hydrolysis of 70 to 100 mol %, preferably 80 to 90 mol %, particularly preferably 81 to 89 mol %, and in particular 82 to 88 mol %. In a preferred embodiment, the water-soluble material contains at least 20 wt %, particularly preferably at least 40 wt %, exceedingly preferably at least 60 wt %, and in particular at least 80 wt %, of a polyvinyl alcohol having a degree of hydrolysis of 70 to 100 mol %, preferably 80 to 90 mol %, particularly preferably 81 to 89 mol %, and in particular 82 to 88 mol %.

The polyvinyl alcohols described above are widely commercially available, for example under the trademark Mowiol® (Clariant). Polyvinyl alcohols that are particularly suitable in the scope of the present invention are, for example, Mowiol® 3-83, Mowiol® 4-88, Mowiol® 5-88, Mowiol® 8-88, L648, L734, Mowiflex LPTC 221 from KSE, and the compounds from Texas Polymers, such as Vinex 2034.

The water solubility of PVAL can be changed by posttreatment with aldehydes (acetalation) or ketones (ketalization). Polyvinyl alcohols that are acetalated or ketalized with the aldehyde or keto groups of saccharides or polysaccharides or mixtures thereof have proven to be particularly preferred and, because of the remarkably good cold water solubility thereof, particularly advantageous. The use of the reaction products of PVAL and starch is extremely advantageous.

Furthermore, the water solubility can be changed by complexation with Ni salts or Cu salts or by treatment with dichromates, boric acid, or borax and thus set to desired values in a targeted manner. Films made of PVAL are largely impermeable to gases, such as oxygen, nitrogen, helium, hydrogen, and carbon dioxide, but allow water vapor to pass through.

Preferred water-soluble materials are characterized in that said materials comprise hydroxypropyl methyl cellulose (HPMC) having a degree of substitution (average number of methoxy groups per anhydroglucose unit of the cellulose) of 1.0 to 2.0, preferably 1.4 to 1.9, and a molar substitution (average number of hydroxypropyl groups per anhydroglucose unit of the cellulose) of 0.1 to 0.3, preferably 0.15 to 0.25.

Polyvinylpyrrolidones (abbreviation: PVP) are produced by the radical polymerization of 1-vinylpyrrolidone. Commercially available PVPs have molar masses in the range of approximately 2,500 to 750,000 g/mol and are offered as white, hygroscopic powders or as aqueous solutions.

Polyethylene oxides (abbreviation: PEO) are polyalkylene glycols of the general formula

H—[O—CH₂—CH₂]ₙ—OH

that are technically produced by the basically catalyzed polyaddition of ethylene oxide (oxirane) in systems usually containing small amounts of water, with ethylene glycol as a starting molecule. Polyethylene oxides typically have molar masses in the range of approximately 200 to 5,000,000 g/mol, corresponding to degrees of polymerization n of approximately 5 to >100,000. Polyethylene oxides have an extremely low concentration of reactive hydroxy end groups and exhibit only weak glycol properties.

Gelatin is a polypeptide (molar mass: approximately 15,000 to >250,000 g/mol) that is obtained principally by the hydrolysis of the collagen contained in the skin and bones of animals under acidic or alkaline conditions. The amino acid composition of the gelatin largely corresponds to that of the collagen from which the gelatin was obtained and varies in accordance with the origin of said collagen. The use of gelatin as a water-soluble casing material is very widespread in particular in pharmacy in the form of hard or soft gelatin capsules. Gelatin is rarely used in the form of films because the price of gelatin is high in comparison with the price of the polymers mentioned above.

In the scope of the present invention, water-soluble materials that comprise a polymer from the group of starch and starch derivatives, cellulose and cellulose derivatives, in particularly methyl cellulose, and mixtures thereof are preferred.

Starch is a homoglycan, wherein the glucose units are a-glycosidically bonded. Starch is constructed from two components of different molecular weight (MW): from approximately 20 to 30% of straight-chain amylose (MW of approximately 50,000 to 150,000) and 70 to 80% of branched-chain amylopectin (MW of approximately 300,000 to 2,000,000). In addition, small amounts of lipids, phosphoric acid, and cations are also contained. While the amylose forms long, helical, intertwined chains having approximately 300 to 1,200 glucose molecules because of the bonding in the 1,4-position, in amylopectin the chain is branched after 25 glucose structural units on average by means of a 1-6 bond to form a branch structure having approximately 1,500 to 12,000 molecules of glucose. In addition to pure starch, starch derivatives obtainable from starch by polymer-analogous reactions are also suitable for producing water-soluble receptacles in the scope of the present invention. Such chemically modified starches comprise, for example, products from esterifications or etherifications in which hydroxy hydrogen atoms were substituted. However, starches in which the hydroxy groups were replaced by functional groups that are not bonded by means of an oxygen atom also can be used as starch derivatives. For example, alkali starches, carboxymethyl starch (CMS), starch esters and ethers, and amino starches fall in the group of the starch derivatives.

Pure cellulose has the formal gross composition (C₆H₁₀O₅) and, formally, is a β-1,4-polyacetal of cellobiose, which in turn is constructed from two molecules of glucose. Suitable celluloses consist of approximately 500 to 5,000 glucose units and accordingly have average molar masses of 50,000 to 500,000. In the scope of the present invention, cellulose derivatives obtainable from cellulose by polymer-analogous reactions also can be used as cellulose-based disintegration agents. Such chemically modified celluloses comprise, for example, products from esterifications or etherifications in which hydroxy hydrogen atoms were substituted. However, celluloses in which the hydroxy groups were replaced by functional groups that are not bonded by means of an oxygen atom also can be used as cellulose derivatives. For example, alkali celluloses, carboxymethyl cellulose (CMC), cellulose esters and ethers, and amino celluloses fall in the group of the cellulose derivatives.

The water-soluble material can have further additives. Said further additives are, for example, plasticizers, such as dipropylene glycol, ethylene glycol, or diethylene glycol, water, or decomposing agents.

Polyvinyl alcohol is particularly preferably used as a water-soluble material. Polyvinyl alcohol is easy to process and inexpensive. In addition, polyvinyl alcohol is particularly highly soluble in water and thus enables a variety of usage possibilities of the produced receptacle.

Films sold by MonoSol LLC under the name Monosol M8630 are suitable water-soluble films for use as a water-soluble material of the portion according to the invention. Other suitable films include films with the names Solublon® PT, Solublon® KA, Solublon® KC, or Solublon® KL from Aicello Chemical Europe GmbH or the films VF-HP from Kuraray.

In another embodiment, the problem addressed by the present invention is solved by a portioned washing, cleaning, or pretreatment agent in a previously described water-soluble receptacle. In particular, the washing, cleaning, or pretreatment agent is liquid.

The washing, cleaning, or pretreatment agent according to the invention can be a typical, in particular liquid washing, cleaning, or pretreatment agent known in the prior art. Corresponding, in particular, agents comprise at least one surfactant, selected from non-ionic, anionic, and amphoteric surfactants. Suitable liquid washing, cleaning, or pretreatment agents are described, for example, in WO 2011/117079 A1, WO 2013/186170 A1, or WO 2013/107579 A1, which are hereby expressly referenced.

The washing, cleaning, or pretreatment agent comprises or more washing- or cleaning-active substances, preferably selected form the group of the builders, surfactants, polymers, bleaching agents, bleach activators, enzymes, corrosion inhibitors, and disintegration auxiliaries.

Unless otherwise stated, percent specifications in the present application relate to weight percent, i.e. to weight percent of active matter or odorant with respect to the weight of the washing, cleaning, or pretreatment agent. Here, active matter means the fraction that is active, i.e. effective, in the washing, cleaning, or pretreatment agent. If ranges are specified, the values located within the ranges should also be regarded as disclosed.

The group of the surfactants includes the non-ionic, anionic, cationic, and amphoteric surfactants. According to the invention, the washing, cleaning, or pretreatment agent can comprise one or more of the mentioned surfactants. The washing, cleaning, or pretreatment agent particularly preferably comprises one or more anion surfactants (anionic surfactants), which are contained preferably in a proportion of 20 to 50%, in particular 25 to 35%.

The at least one anionic surfactant is preferably selected from the group comprising C₉ to C₁₃ alkylbenzene sulfonates, olefin sulfonates, C₁₂ to C₁₈ alkane sulfonates, ester sulfonates, alk(en)yl sulfates, fatty alcohol ether sulfates, and mixtures thereof. It has been found that said sulfonate and sulfate surfactants are particularly well suited for the production of stable liquid compositions having a yield point. Liquid compositions that comprise C₉ to C₁₃ alkylbenzene sulfonates and fatty alcohol ether sulfates as an anionic surfactant have particularly good dispersing properties. Preferably C₉ to C₁₃ alkylbenzene sulfonates, and olefin sulfonates, i.e. mixtures of alkene and hydroxyalkane sulfonates and disulfonates, which can be obtained for example from C₁₂ to C₁₈ monoolefins having terminal or internal double bonds by sulfonation with gaseous sulfur trioxide and subsequent alkaline or acidic hydrolysis of the sulfonation products, are considered as surfactants of the sulfonate type. C₁₂ to C₁₈ alkane sulfonates and the esters of α-sulfo fatty acids (ester sulfonates), for example the α-sulfonated methyl esters of hydrogenated coconut, palm kernel, or tallow fatty acids, are also suitable.

The alkali salts and in particular the sodium salts of the sulfuric acid semiesters of the C₁₂ to C₁₈ fatty alcohols, for example from coconut fatty alcohol, tallow fatty alcohol, lauryl, myristyl, cetyl, or stearyl alcohol, or of the C₁₀ to C₂₀ oxo alcohols and the semiesters of secondary alcohols of these chain lengths are preferred as alk(en)yl sulfates. From the perspective of washing technology, the C₁₂ to C₁₆ alkyl sulfates, C₁₂ to C₁₅ alkyl sulfates, and C₁₄ to C₁₅ alkyl sulfates are preferred. 2,3-Alkyl sulfates also are suitable anionic surfactants.

Fatty alcohol ether sulfates, such as the sulfuric acid monoesters of the straight-chain or branched C₇ to C₂₁ alcohols ethoxylated with 1 to 6 mol of ethylene oxide, such as 2-methyl-branched C₉ to C₁₁ alcohols having 3.5 mol of ethylene oxide (EO) on average or C₁₂ to C₁₈ fatty alcohols having 1 to 4 EO, also are suitable.

It is preferred that the washing, cleaning, or pretreatment agent contains a mixture of sulfonate and sulfate surfactants. In a particularly preferred embodiment, the composition contains C₉ to C₁₃ alkylbenzene sulfonates and fatty alcohol ether sulfates as an anionic surfactant.

In addition to the anionic surfactant, the agent can also contain soaps. Saturated and unsaturated fatty acid soaps, such as the salts of lauric acid, myristic acid, palmitic acid, stearic acid, (hydrogenated) erucic acid, and behenic acid, and in particular soap mixtures derived from natural fatty acids such as coconut, palm kernel, olive oil, or tallow fatty acids are suitable.

The anionic surfactants and the soaps can be in the form of the sodium, potassium, magnesium, or ammonium salts thereof. The anionic surfactants are preferably in the form of the sodium salts thereof. Other preferred counterions for the anionic surfactants are the protonated forms of choline, triethylamine, monoethanolamine, or methylethylamine.

In addition to the anionic surfactant, the agent can also have at least one non-ionic surfactant. The non-ionic surfactant comprises alkoxylated fatty alcohols, alkoxylated fatty acid alkyl esters, fatty acid amides, alkoxylated fatty acid amides, polyhydroxy fatty acid amides, alkylphenol polyglycol ethers, amine oxides, alkyl polyglucosides, and mixtures thereof.

Alkoxylated, advantageously ethoxylated, in particular primary alcohols having preferably 8 to 18 C atoms and on average 4 to 12 mol of ethylene oxide (EO) per mol of alcohol, in which the alcohol functional group can be linear or preferably methyl-branched in the 2-position or can contain linear and methyl-branched functional groups in mixture, as are typically present in oxo alcohol functional groups, are preferably used as a non-ionic surfactant. In particular, however, alcohol ethoxylates having linear functional groups from alcohols of native origin having 12 to 18 C atoms, for example from coconut, palm, or tallow fatty alcohol or oleyl alcohol, and on average 5 to 8 EO per mol of alcohol are preferred. The preferred ethoxylated alcohols include, for example, C₁₂ to C₁₄ alcohols having 4 EO or 7 EO, C9 to CH alcohol having 7 EO, C₁₃ to C₁₅ alcohols having 5 EO, 7 EO, or 8 EO, C₁₂ to C₁₈ alcohols having 5 EO or 7 EO, and mixtures thereof. The specified degrees of ethoxylation are statistical means, which, for a specific product, can be an integer or a fraction. Preferred alcohol ethoxylates have a narrow homolog distribution (narrow range ethoxylates, NREs). In addition to said non-ionic surfactants, fatty alcohols having more than 12 EO also can be used. Examples of these are tallow fatty alcohol having 14 EO, 25 EO, 30 EO, or 40 EO. Non-ionic surfactants that contain EO and PO (propylene oxide) groups together in the molecule also can be used according to the invention. Furthermore, a mixture of a (more highly) branched ethoxylated fatty alcohol and an unbranched ethoxylated fatty alcohol, such as a mixture of a C₁₆ to C₁₈ fatty alcohol having 7 EO and 2-propylheptanol having 7 EO, is also suitable. The washing, cleaning, or posttreatment agent or washing auxiliary particularly preferably contains a C12-18 fatty alcohol having 7 EO or a C₁₃ to C₁₅ oxo alcohol having 7 EO as a non-ionic surfactant.

The washing, cleaning, or pretreatment agent can also comprise one or more solvents. Said solvents can be water and/or non-aqueous solvents. The composition preferably contains water as a main solvent. The composition can also comprise non-aqueous solvents. Suitable non-aqueous solvents include mono- or polyhydric alcohols, alkanolamines, or glycol ethers. The solvents are preferably selected from ethanol, n-propanol, i-propanol, butanols, glycol, propanediol, butanediol, methylpropanediol, glycerol, diglycol, propyldiglycol, butyldiglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl ether, propylene glycol ethyl ether, propylene glycol propyl ether, dipropylene glycol monomethyl ether, dipropylene glycol monoethyl ether, methoxytriglycol, ethoxytriglycol, butoxytriglycol, 1-butoxyethoxy-2-propanol, 3-methyl-3-methoxybutanol, propylene glycol t-butyl ether, di-n-octylether, and mixtures of these solvents.

According to the invention, the composition can also comprise builders and/or alkaline substances. Polymeric polycarboxylates, for example, are suitable as builders. These are, for example, the alkali-metal salts of polyacrylic acid or of polymethacrylic acid, for example those having a relative molecular mass of 600 to 750,000 g/mol.

Suitable polymers are, in particular, polyacrylates, which preferably have a molecular mass of 1,000 to 15,000 g/mol. From this group, in turn, the short-chain polyacrylates having molar masses of 1,000 to 10,000 g/mol, and particularly preferably 1,000 to 5,000 g/mol, can be preferred because of the superior solubility thereof.

Also suitable are copolymeric polycarboxylates, in particular those of acrylic acid with methacrylic acid and of acrylic acid or methacrylic acid with maleic acid. In order to improve the water solubility, the polymers can also contain allyl sulfonic acids, such as allyloxy benzene sulfonic acid and methallyl sulfonic acid, as monomers.

In particular, silicates, aluminum silicates (in particular zeolites), carbonates, salts of organic di- and polycarboxylic acids, and mixtures of these substances should also be mentioned as builders that can be contained in the composition according to the invention.

Organic builders that can also be present in the composition according to the invention are, for example, the polycarboxylic acids, which can be used in the form of the sodium salts thereof, the term “polycarboxylic acids” being understood to mean carboxylic acids that bear more than one acid function. These are, for example, citric acid, adipic acid, succinic acid, glutaric acid, malic acid, tartaric acid, maleic acid, fumaric acid, sugar acids, amino carboxylic acids, nitrilotriacetic acid (NTA), methyl glycine diacetic acid (MGDA), derivatives thereof, and mixtures thereof. Preferred salts are the salts of the polycarboxylic acids such as citric acid, adipic acid, succinic acid, glutaric acid, tartaric acid, sugar acids, and mixtures thereof.

However, soluble builders, such as citric acid, or acrylic polymers having molar masses of 1,000 to 5,000 g/mol are preferably used.

According to the present invention, alkaline substances or washing alkalis are chemicals for raising and stabilizing the pH value of the composition.

In a preferred embodiment, the washing, cleaning, or pretreatment agent also comprises at least one enzyme. Suitable enzymes are the enzymes previously mentioned as an additive. According to the invention, it is also possible that several different enzymes are comprised. In particular, granular enzyme materials are contained in a proportion of 4 to 15 wt %, preferably 7 to 12 wt %, with respect to 100 wt % of the entire washing, cleaning, or pretreatment agent. In a particularly preferred embodiment, the at least one enzyme is in the form of a granular material.

The washing, cleaning, or pretreatment agent according to the invention contains enzymes preferably in total amounts of 1×10⁻⁸ to 5 wt % with respect to active protein. The enzymes are preferably contained in said washing, cleaning, or pretreatment agents in a total amount of 0.001 to 4 wt %, more preferably 0.01 to 3 wt %, even more preferably 0.05 to 1.25 wt %, and particularly preferably 0.2 to 1.0 wt %.

In principle, all of the enzymes established for textile treatment in the prior art are suitable for use as an additive as an enzyme. Preferred are one or more enzymes that can exhibit catalytic activity as an additive of a washing agent, in particular a protease, amylase, lipase, cellulase, hemicellulase, mannanase, pectinolytic enzyme, tannase, xylanase, xanthanase, β-glucosidase, carrageenase, perhydrolase, oxidase, oxidoreductase, and mixtures thereof. Preferred suitable hydrolytic enzymes comprise, in particular, proteases, amylases, in particular α-amylases, cellulases, lipases, hemicellulases, in particular pectinases, mannanases, β-glucanases, and mixtures thereof. Proteases, amylases, and/or lipases and mixtures thereof are particularly preferred, and proteases are exceedingly preferred. In principle, these enzymes are of natural origin; on the basis of the natural molecules, variants improved for use in washing, cleaning, or pretreatment agents are available and are accordingly preferably used.

Among the proteases, those of the subtilisin type are preferred. Examples thereof are the subtilisins BPN′ and Carlsberg, protease PB92, subtilisins 147 and 309, the alkaline protease from Bacillus lentus, subtilisin DY, and the enzymes (which should be classed as subtilases but no longer as subtilisins in the narrower sense) thermitase, proteinase K, and proteases TW3 and TW7. Subtilisin Carlsberg is available in a further developed form under the trade name Alcalase® from Novozymes A/S, Bagsvaerd, Denmark. Subtilisins 147 and 309 are sold under the trade name Esperase®, or Savinase®, by Novozymes. The protease variants having the name BLAP® are derived from the protease from Bacillus lentus DSM 5483. Further usable proteases are, for example, the enzymes available from Novozymes under the trade names Durazym®, Relase®, Everlase®, Nafizym®, Natalase®, Kannase®, and Ovozyme®, the enzymes available from Genencor under the trade names Purafect®, Purafect® OxP, Purafect® Prime, Excellase®, and Properase®, the enzyme available from Advanced Biochemicals Ltd., Thane, India, under the trade name Protosol®, the enzyme available from Wuxi Snyder Bioproducts Ltd., China, under the trade name Wuxi®, the enzymes available from Amano Pharmaceuticals Ltd., Nagoya, Japan, under the trade names Proleather® and Protease P®, and the enzyme available from Kao Corp., Tokyo, Japan, under the name Proteinase K-16. The proteases from Bacillus gibsonii and Bacillus pumilus are also particularly preferably used.

Examples of amylases that can be used according to the invention are the α-amylases from Bacillus licheniformis, from B. amyloliquefaciens, or from B. stearothermophilus and the further developments thereof improved for use in washing, cleaning, or pretreatment agents. The enzyme from B. licheniformis is available from Novozymes under the name Termamyl® and from Genencor under the name Purastar® ST. Products of the further development of these α-amylases are available from Novozymes under the trade names Duramyl® and Termamyl® ultra, from Genencor under the name Purastar® OxAm, and from Daiwa Seiko Inc., Tokyo, Japan, as Keistase®. The α-amylase from B. amyloliquefaciens is sold by Novozymes under the name BAN®, and derived variants of the α-amylase from B. stearothermophilus are sold likewise by Novozymes under the names BSG® and Novamyl®. Furthermore, the α-amylase from Bacillus sp. A 7-7 (DSM 12368) and the cyclodextrin glucanotransferase (CGTase) from B. agaradherens (DSM 9948) should be emphasized for this purpose. Likewise, fusion products of all mentioned molecules can be used. Furthermore, the further developments of the α-amylase from Aspergillus niger and A. oryzae available from Novozymes under the trade name Fungamyl® are suitable. Other advantageously usable commercial products are, for example, Amylase-LT® and Stainzyme® or Stainzyme ultra® or Stainzyme plus®; the latter are likewise from Novozymes. Variants of these enzymes that can be obtained by point mutations also can be used according to the invention.

Examples of lipases or cutinases that can be used according to the invention, which are contained in particular because of the triglyceride-cleaving activity thereof but also in order to produce peracids in situ from suitable precursors, are the lipases originally available from Humicola lanuginosa (Thermomyces lanuginosus) or further developed, in particular those having the amino acid exchange D96L. These are sold, for example, by Novozymes under the trade names Lipolase®, Lipolase® Ultra, LipoPrime®, Lipozyme®, and Lipex®. Furthermore, the cutinases originally isolated from Fusarium solani pisi and Humicola insolens can be used, for example. Other usable lipases are available from Amano under the names Lipase CE®, Lipase P®, Lipase B®, or Lipase CES®, Lipase AKG®, Bacillus sp. Lipase®, Lipase AP®, Lipase M-AP®, and Lipase AMIL®. From Genencor, the lipases or cutinases whose starting enzymes were originally isolated from Pseudomonas mendocina and Fusarium solanii can be used, for example. The preparations M1 Lipase® and Lipomax® originally sold by Gist-Brocades and the enzymes sold by Meito Sangyo KK, Japan, under the names Lipase MY-30®, Lipase OF®, and Lipase PL® should be mentioned as other important commercial products, as well as the product Lumafast® from Genencor.

Depending on the purpose, cellulases can be in the form of pure enzymes, enzyme preparations, or mixtures in which the individual components advantageously complement each other with respect to various performance aspects of the components. Said performance aspects include, in particular, the contributions of the cellulase to the primary washing performance of the agent (cleaning performance), to the secondary washing performance of the agent (anti-redeposition effect or graying inhibition), to softening (fabric effect), or to the application of a stone-washed effect. A usable fungal, endoglucanase (EG)-rich cellulase preparation or the further developments thereof are offered by Novozymes under the trade name Celluzyme®. The products Endolase® and Carezyme®, which are also available from Novozymes, are based on the 50-kD EG, or the 43-kD EG from H. insolens DSM 1800. Other usable commercial products from this company are Cellusoft®, Renozyme®, and Celluclean®. Also usable are, for example, the 20-kD EGs from Melanocarpus, which are available from AB Enzymes, Finland, under the trade name Ecostone® and Biotouch®. Other commercial products from AB Enzymes are Econase® and Ecopulp®. Other suitable cellulases are from Bacillus sp. CBS 670.93 and CBS 669.93, the cellulase from Bacillus sp. CBS 679.93 being available from Genencor under the trade name Puradax®. Other commercial products from Genencor are “Genencor detergent cellulase L” and IndiAge® Neutra. Variants of these enzymes that can be obtained by point mutations also can be used according to the invention. Particularly preferred cellulases are Thielavia terrestris cellulase variants, cellulases from Melanocarpus, in particular Melanocarpus albomyces, cellulases of the EGIII type from Trichoderma reesei, or variants that can be obtained therefrom.

Furthermore, other enzymes, summarized under the term “hemicellulases”, can be used, in particular to remove certain problematic stains. Said enzymes include, for example, mannanases, xanthan lyases, xanthanases, xyloglucanases, xylanases, pullulanases, pectinolytic enzymes, and β-glucanases. The β-glucanase obtained from Bacillus subtilis is available from Novozymes under the name Cereflo®. Hemicellulases particularly preferred according to the invention are mannanases, which are sold, for example, by Novozymes under the trade name Mannaway® and by Genencor under the trade name Purabrite®. In the scope of the present invention, the pectinolytic enzymes also include enzymes having the names pectinase, pectate lyase, pectinesterase, pectin demethoxylase, pectin methoxylase, pectin methylesterase, pectase, pectin methylesterase, pectinoesterase, pectin pectylhydrolase, pectin depolymerase, endopolygalacturonase, pectolase, pectin hydrolase, pectin polygalacturonase, endo-polygalacturonase, poly-α-1,4-galacturonide glycanohydrolase, endogalacturonase, endo-D-galacturonase, galacturan 1,4-α-galacturonidase, exopolygalacturonase, poly(galacturonate) hydrolase, exo-D-galacturonase, exo-D-galacturonanase, exopoly-D-galacturonase, exo-poly-α-galacturonosidase, exopolygalacturonosidase, or exopolygalacturanosidase. Examples of enzymes suitable in this regard are available, for example, from Novozymes under the names Gamanase®, Pektinex AR®, X-Pect®, or Pectaway®, from AB Enzymes under the names Rohapect UF®, Rohapect TPL®, Rohapect PTE100®, Rohapect MPE®, Rohapect MA plus HC, Rohapect DA12L®, Rohapect 10L®, and Rohapect B1L®, and from Diversa Corp., San Diego, Calif., USA, under the name Pyrolase®.

Among all these enzymes, those which in themselves are relatively stable with respect to oxidation or have been stabilized with respect to oxidation, for example by point mutagenesis, are particularly preferred. Among these, in particular the already mentioned commercial products Everlase® and Purafect® OxP should be mentioned as examples of such proteases and Duramyl® should be mentioned as an example of such an α-amylase.

It is preferred that an optical brightener, as an additive, is selected from the substance classes of the distyrylbiphenyls, the stilbenes, the 4,4′-diamino-2,2′-stilbenedisulfonic acids, the coumarins, the dihydroquinolinones, the 1,3-diarylpyrazolines, the naphthalic acid imides, the benzoxazole systems, the benzisoxazole systems, the benzimidazole systems, the pyrene derivatives substituted with heterocycles, and mixtures thereof. Said substance classes of optical brighteners have high stability, high light resistance, high oxygen resistance, and a high affinity for fibers.

The following optical brighteners, which are selected from the group consisting of disodium 4,4′-bis(2-morpholino-4-anilino-s-triazin-6-ylamino)stilbene-disulfonate, disodium 2,2′-bis(phenyl-styryl)-disulfonate, 4,4′-bis[(4-anilino-6-[bis(2-hydroxyethyl) amino]-1,3,5-triazin-2-yl)amino]stilbene-2,2′-disulfonic acid, hexasodium 2,2′-[vinylene-bis[(3-sulfonato-4,1-phenylene)imino[6-(diethylamino)-1,3,5-triazine-4,2-diyl]imino ]]-bis(benzene-1,4-disulfonate), 2,2′-(2,5-thiophenediyl)-bis[5-1,1-dim, can be incorporated as an additive particularly well and stably.

The liquid washing, cleaning, or pretreatment agent can have one or more further components described in the prior art, such as optical brighteners, complexing agents, bleaching agents, bleach activators, antioxidants, enzyme stabilizers, antimicrobial active ingredients, graying inhibitors, anti-redeposition agents, pH adjusters, electrolytes, detergent boosters, vitamins, proteins, suds suppressors, and/or UV absorbers.

In a further embodiment, the problem addressed by the present invention is solved by means of a method for producing a water-soluble receptacle from a film having a first surface, which forms the inner face of the receptacle, and a second surface, which lies opposite the first surface, wherein first a receptacle is formed from the film and then the second surface is provided with a coating over the full area or part of the area of the second surface.

An alternative method provides that first the second surface of a film is provided with a full-area or partial-area coating and then a receptacle is formed from the coated film.

The receptacle can be produced in accordance with methods common in the prior art, such as deep drawing, injection molding, or compression molding. The coating process can be performed before or after the actual receptacle has been formed, depending on the production method. In particular, if certain motifs should be visible on the surface of the receptacle by virtue of the coating, the coating process is preferably performed after the actual receptacle has been formed. If simple geometric patterns should be created, a coating process can also be performed before the formation process, in which case it must be noted that the actual form can be changed, for example by the deep drawing process.

The coating can be applied in accordance with known methods. If the polymeric active ingredient is in the form of a solution or dispersion, for example, the polymeric active ingredient can be put on the surface over the full area or part of the area thereof in accordance with common methods, for example by pouring the polymeric active ingredient over the surface, applying the polymeric active ingredient to the surface, or brushing the polymeric active ingredient onto the surface. Immersing the film in a solution or dispersion that has the polymeric active ingredient is also possible. After the solvent of the solution/dispersion that comprises the polymeric active ingredient has evaporated, the polymeric active ingredient is on the second surface as a coating.

Polymers that are not soluble or dispersible or that are poorly soluble or dispersible in a suitable solvent can also be applied to the second surface of the receptacle in the form of the melt of said polymers. For this purpose, the polymeric active ingredient can be melted alone or together with a plasticizer. The plasticizer influences the viscosity and thus the processability of the obtained melt. The melt can then be applied to the second surface of the receptacle similarly to a solution or dispersion. In particular, if the melt is in the form of a highly viscous liquid, targeted application can be performed by means of an appropriate device, such as a melt jet gun or a spray nozzle, so that defined patterns thus can be applied to the second surface of the receptacle.

It is also conceivable that the polymeric active ingredient and possibly further components of the coating are applied to the second surface of the water-soluble receptacle by means of a 3-D printer or by means of laser sintering. A wide range of methods known in the prior art can be implemented. It must be ensured that, at the time at which the coating comes in contact with the second surface of the receptacle, the coating has a temperature that does not attack the material of the water-soluble receptacle so that the receptacle does not have any defects.

The type of processing determines the further composition of the coating with respect to additives, such as plasticizers and solvents.

The coating preferably always has so much polymeric active ingredient that, per gram of bag, an amount of 0.001 to 0.5 g, in particular 0.01 to 0.3 g, of polymeric active ingredient is present as a coating.

In the embodiment example below, the present invention is presented in a non-limiting manner, as an example. In the scope of the present invention, all previously presented and also preferred embodiments or the described features can also be individually combined with each other. Furthermore, in the scope of the present invention, the term “comprise” also covers the alternative in which the products/methods/uses with respect to which the term “comprising” is used consist exclusively of the elements then consisting therein.

Embodiment example

Application of a soil release polymer to pouches

A non-ionic polyester that can be obtained from Clariant under the name TexCare® SRA 300 F was used as a soil release polymer. Said polyester was mixed with liquid triethyl acetate (plasticizer) in a beaker. The weight percentage of TexCare was 72.5%, and that of the plasticizer was 27.5%.

A melt jet gun (model OptiMek 100) was heated to approximately 125° C. The mixture of polymer and plasticizer was melted in the beaker and homogenized at temperatures of 120 to 130° C. in order to avoid separation of materials in the cylinder of the melt jet gun.

The melted mass was then poured from the beaker into the pressure cylinder of the melt jet gun.

It was possible to apply the melt at a pressure between 4 and 5.5 bar in a nozzle of 0.5 to 1 mm from the melt jet gun to a polyvinyl alcohol receptacle in different forms as patterns without the receptacle thereby being damaged. The achieved partial-area coating was clearly detectable as an opaque pattern and visibly stood out from the transparent receptacle.

What is claimed is:

1. A water-soluble receptacle for a washing, cleaning, or pretreatment agent, comprising a first surface, which forms the inner face of the receptacle, and a second surface on the outer face of the receptacle, which second surface lies opposite said first surface, wherein the second surface has a coating over the full area or part of the area of the second surface and said coating comprises at least one washing-active polymeric active ingredient.

2. The water-soluble receptacle according to claim 1, wherein the at least one washing-active polymeric active ingredient is selected from the group consisting of the soil release polymers, polymeric graying inhibitors, polymeric primary-detergency intensifiers, polymeric softeners, polymeric anti-wrinkling active ingredients, and mixtures thereof.

3. The water-soluble receptacle according to claim 1, wherein the at least one washing-active polymeric active ingredient comprises a soil release polymer.

4. The water-soluble receptacle according to claim 2, wherein the soil release polymer has at least one terephthalate group and/or is a polyester.

5. The water-soluble receptacle according to claim 1, wherein coating also has at least one plasticizer.

6. The water-soluble receptacle according to claim 5, wherein the plasticizer is selected from dioctyl phthalate, phosphoric acid ester, alkylsulfonic acid ester, and/or citric acid triethyl ester.

7. The water-soluble receptacle according to claim 1, wherein the coating also has optical auxiliaries.

8. The water-soluble receptacle according to claim 1, wherein said water-soluble receptacle comprises PVA.

9. A portioned washing, cleaning, or pretreatment agent in a water-soluble receptacle according to claim 1.

10. The portioned washing, cleaning, or pretreatment agent according to claim 9, wherein said washing, cleaning, or pretreatment agent is liquid.

11. A method for producing a water-soluble receptacle from a film having a first surface, which forms the inner face of the receptacle, and having a second surface on the outer face of the receptacle, which second surface lies opposite said first surface, wherein first a receptacle is formed from the film and then the second surface is provided with a coating over the full area or part of the area of the second surface.

12. The method for producing a water-soluble receptacle from a film having a first surface, which forms the inner face of the receptacle, and having a second surface on the outer face of the receptacle, which second surface lies opposite said first surface, wherein the second surface is provided with a full-area or partial-area coating and then a receptacle is formed from the film.

13. The water-soluble receptacle according to claim 3, wherein the at least one washing-active polymeric active ingredient comprises an anionic soil release polymer.

14. The water-soluble receptacle according to claim 3, wherein the at least one washing-active polymeric active ingredient comprises a non-ionic soil release polymer.

15. The water-soluble receptacle according to claim 6, wherein the plasticizer is selected from dioctyl phthalate.

16. The water-soluble receptacle according to claim 6, wherein the plasticizer is selected from phosphoric acid ester.

17. The water-soluble receptacle according to claim 6, wherein the plasticizer is selected from alkylsulfonic acid ester.
